(19) United States
(12) Patent Application Publication
(10) Pub. No.: US 2026/0086189 A1
(43) Pub. Date: Mar. 26, 2026

(54) LOCATION SERVICES BASED ON RADIO FREQUENCY (RF) TAG LOCATION INFORMATION

(71) Applicant: QUALCOMM Incorporated, San Diego, CA (US)

(72) Inventors: Gang DING, San Diego, CA (US); Joseph Patrick BURKE, Carlsbad, CA (US)

(21) Appl. No.: 18/891,797

(22) Filed: Sep. 20, 2024

(51) Int. Cl. G01S 5/02; G01S 5/06

(52) U.S. Cl. CPC G01S 5/0257; G01S 5/06

(57) ABSTRACT

An example method performed by a server for providing location services can include receiving, from a stationary RF tag reader, one or more measurements indicative of an RF tag; receiving one or more ranging measurements with the RF tag from at least a first mobile RF tag reader located at a first location; obtaining a second location associated with the stationary RF tag reader; and determining hybrid location information for the RF tag based on the one or more ranging measurements, the first location, and the second location. In an example implementation. the hybrid location information may be provided to a client entity.

### BACKGROUND

### 1. Field of Disclosure

The present disclosure relates generally to the field of location services and more specifically pertains to location services that include radio frequency (RF) tag location information.

### 2. Description of Related Art

Machine-readable information associated with various objects can be obtained via use of various types of devices and various techniques. The obtained information can be used in various ways. For example, information pertaining to an item sold in a store, such as for example, nutritional content of an edible item, may be obtained by using a smartphone to scan a QR code attached to the item. Information pertaining to the nutritional content may be used by a customer to make a decision whether to purchase the edible item. As another example, a store employee may perform a sales checkout procedure upon an item based on using a bar code scanner to scan a bar code affixed to the item. As yet another example, a global positioning system (GPS) tracker attached to, or contained in, an object such as a phone, for example, can be tracked by use of a GPS tracker. Information obtained via the GPS tracker may be used by the owner of the phone to locate the phone when lost, misplaced, or stolen.

Another device that can be used for providing machine-readable information is what is known as a radio frequency identification (RFID) tag. An RFID tag is generally attachable to any of various types of objects and is typically a low cost item that includes a memory in which a limited amount of machine-readable information (such as, for example, a tracking number) can be stored. The machine-readable information typically fails to provide any information pertaining to a location of the RFID tag.

### BRIEF SUMMARY

Embodiments described herein pertain to location services that are based on radio frequency (RF) tags. An example method performed by a server for providing location services can include receiving, from a stationary RF tag reader, one or more measurements indicative of an RF tag; receiving one or more ranging measurements with the RF tag from at least a first mobile RF tag reader located at a first location; obtaining a second location associated with the stationary RF tag reader; and determining hybrid location information for the RF tag based on the one or more ranging measurements, the first location, and the second location.

An example server for providing location services can include a memory and one or more processors communicatively coupled with the memory. The one or more processors are configured to receive, from a stationary RF tag reader, one or more measurements indicative of an RF tag; receive one or more ranging measurements with the RF tag from at least a first mobile RF tag reader located at a first location; obtain a second location associated with the stationary RF tag reader; and determine hybrid location information for the RF tag based on the one or more ranging measurements, the first location, and the second location.

An example apparatus for providing location services can include means for receiving, from a stationary RF tag reader, one or more measurements indicative of an RF tag; means for receiving one or more ranging measurements with the RF tag from at least a first mobile RF tag reader located at a first location; means for obtaining a second location associated with the stationary RF tag reader; and means for determining hybrid location information for the RF tag based on one or more ranging measurements, the first location, and the second location.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 shows a simplified version of a location services system according to a first embodiment.

FIG. 2 shows a simplified version of a location services system according to a second embodiment.

FIG. 3 shows a simplified version of a location services system according to a third embodiment.

FIG. 4 shows a simplified version of a location services system according to a fourth embodiment.

FIG. 5 shows a flow diagram of an example method for providing location services according to an embodiment.

FIG. 6 is a diagram showing some example functional elements of a server according to an embodiment.

FIG. 7 is a diagram showing some example functional elements of a radio frequency (RF) tag reader according to an embodiment.

FIG. 8 is a block diagram of some example components that can be included in an RF tag in accordance an embodiment of the disclosure.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example.

Furthermore, particular features, structures, or characteristics described herein may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Various aspects described herein generally relate to systems and methods for providing location services based on RF tags and RF tag readers. One among many examples of an RF tag is an RF identification (RFID) tag. Traditionally, RF tags such as, for example, RFID tags, have been used in tracking applications such as, for example, in asset tracking applications where one or more assets (equipment, items, belongings, etc.) can be tracked. Tracking may be carried out for various reasons such as, for example, for inventory purposes or for security purposes. In some cases, tracking can be carried out by using a hand-held RF tag reader (such as, for example, a hand-held RFID tag reader) and/or an RF tag reader mounted in proximity to a tracked object. In some cases, a tracked object can be in motion and an RF tag reader may be mounted on a doorway of a building or a frame of a conveyer belt in a factory, for example in order to track the object in motion. However, information provided by an RF tag reader may be unsuitable and/or insufficient for accurately identifying a location of the RF tag. Consequently, techniques, such as, for example, GPS techniques, may have to be employed in traditional practice in order to determine a location of the RF tag.

The various example embodiments disclosed herein pertain to the use of location information associated with RF tags. The location information associated with RF tags may be used to derive enhanced hybrid location information that can be used for various purposes. It must be understood that the word “hybrid” as used herein in the phrase “hybrid location information” can involve the use of multiple devices, multiple technologies, and multiple location determination procedures for obtaining location information of one or more RF tags. In an example scenario, hybrid location information for an RF tag may be determined based on one or more measurements received from a stationary RF tag reader, one or more ranging measurements received from a mobile tag reader, and location information associated with the stationary RF tag reader. Enhanced hybrid location information may then be derived by complementing the hybrid location information for the RF tag with location information of an object. The location information of the object can be based on the RF tag attached to the object. The enhanced hybrid location information may be used for various purposes, such as, for example, to track the object having the RF tag attached and/or to identify a location of the tracked object at any given time.

In an example embodiment, the system includes a server that offers location services based on enhanced hybrid location information that not only includes hybrid location information of various types of elements obtained by use of various types of location determination operations and based on technologies such as global navigation satellite system (GNSS), cellular, Wi-Fi, Bluetooth® Low Energy (BLE), and ultra-wide band (UWB), but further includes location information obtained via use of RF tags and RF tag readers in accordance with the disclosure. In an example implementation, enhanced hybrid location information includes location information of an RF tag obtained via an RF tag reading operation performed by of one or more RF tag readers and can further include location information of the RF tag reader(s) that performed the RF tag reading operation. The location information of the RF tag reader(s) can be obtained in various ways, such as, for example, based on the RF tag reader(s) performing location determination operations using technologies such as global navigation satellite system (GNSS), cellular, Wi-Fi, Bluetooth® Low Energy (BLE), and ultra-wide band (UWB). In an example embodiment, a RF tag reader can be a smartphone equipped with an RF tag reader that can include hardware and software configured to perform RF tag reading operations.

Accordingly, particular aspects of the subject matter described in this disclosure can be implemented to realize one or more of the potential advantages described below.

An example advantage associated with providing location services based on enhanced hybrid location information that includes location information related to one or more RF tags and one or more RF tag readers, pertains to a location determination service that provides assistance for determining a location of an object having an attached RF tag such as, for example, an RFID tag.

Other example advantages associated with providing location services based on enhanced hybrid location information that includes location information related to one or more RF tags and one or more RF tag readers pertains to supporting any of one or more of a wide range of services such as, for example, a tracking service, a customer service, and/or a product development service.

As one example of the use of enhanced hybrid location information for a tracking service, a customer seeking to locate a stolen/misplaced item can do so based on using the enhanced hybrid location information to determine a location of the stolen/misplaced item. The location may be determined based on identifying a location of an RF tag attached to the stolen/misplaced item.

The description herein refers to various methods and techniques associated with obtaining location information of one or more RF tags and/or one or more RF tag readers, and using the location information for various purposes such as, for example, in the form of enhanced hybrid location information. It must be understood that these methods and techniques are applicable to various types of tags that are capable of RF communications that can be used for obtaining location information in the manner described herein and for use of the obtained information in the manner described herein. Such tags can include any of various passive tags (battery-less tags), active tags (battery-operated), and semi-active tags. One example of an RF tag is an RFID tag, and one example of an RF tag reader is an RFID tag reader. Other examples of RF tags may include a Bluetooth Low Energy (BLE) tag and an ultra-wideband (UWB) tag.

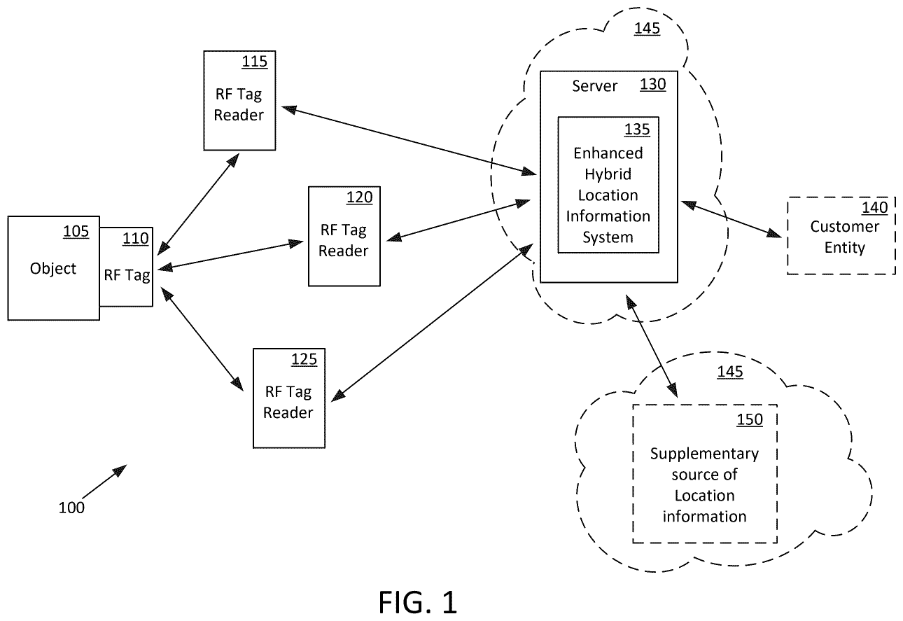

FIG. 1 illustrates a simplified version of an example location services system 100 according to a first embodiment. The techniques described herein may be implemented by one or more components of the example location services system 100. However, the techniques described herein are not limited to such components and may be implemented in other types of systems (not shown). The example location services system 100 includes an RF tag reader 115, an RF tag reader 120, an RF tag reader 125, a server 130, and an RF tag 110 attached to an object 105. The RF tag reader 115, the RF tag reader 120, and the RF tag reader 125 are shown in FIG. 1 for purposes of describing some example operations in accordance the disclosure. In other implementations, less than, or greater than, three RF tag readers can be used.

Furthermore, elements such as a supplementary location information source that is illustrated in the form of a supplementary RF tag reader(s) location information source 150, and a client entity 140 that are shown as included in example location services system 100 can be omitted in some implementations or selectively included in some other implementations.

The example location services system 100 is generally directed at providing enhanced hybrid location services that includes location information associated with one or more RF tags, one or more RF tag readers, and one or more objects having RF tags attached, such as, for example, location information associated with the RF tag 110, the RF tag reader 115, the RF tag reader 120, and the RF tag reader 125. Location information associated with the RF tag 110 automatically provides location information of an object 105 to which the RF tag 110 is attached. The object 105, which can be omitted in some implementations, can be any of various types of animate or inanimate objects. A few examples of inanimate objects may include a vehicle, a phone, a package, an item of merchandise, and an item of produce. A few examples of animate objects may include a pet, a human being, a domesticated animal, a wild bird, and a wild animal.

The RF tag reader 115, the RF tag reader 120, and the RF tag reader 125 can be implemented in any of various forms. In an example scenario, one or more of the three example RF tag readers can be a hand-held device. For example, one or more of the three example RF tag readers can be a smartphone equipped with RF scanning hardware and software configured to perform RF tag reading operations. In another example scenario, one or more of the three example RF tag readers can be a stationary device mounted upon any of various fixtures, such as, for example, an RF tag reader mounted on a doorway of a building, an RF tag reader provided in a vertical pillar located adjacent to a doorway of a store, or an RF tag reader mounted on a frame of a conveyer belt in a manufacturing facility.

More particularly, in the illustrated example embodiment, the RF tag reader 115, the RF tag reader 120, and the RF tag reader 125 are stationary devices that can be used for obtaining location information of the RF tag 110 in accordance with the disclosure.

The server 130 represents one or more computers that include an enhanced hybrid location information system 135. The enhanced hybrid location information system 135 can be generally configured to store enhanced hybrid location information, which includes location information of one or more RF tags, such as, for example, the RF tag 110, and to provide various types of services based on the enhanced hybrid location information.

In an example implementation, the server 130 can be cloud-based (as indicated by cloud 145). and can be accessible to various devices via a network such as, for example, the Internet, a cellular network, or any other wired and/or wireless network. In another example implementation, the server 130 can be a stand-alone device that is configured for direct wireless communications with the three RF tag readers, such as, for example, via Wi-Fi communications or Bluetooth communications.

In one embodiment, the client entity 140 can be one or more computers operated by one or more customers seeking location services and/or other services offered by the enhanced hybrid location information system 135. In an example implementation, the client entity 140 may access the enhanced hybrid location information system 135 for purposes of performing a tracking service, an inventory service, a customer service, and/or a product development service, for example.

The supplementary source of RF tag reader(s) location information source 150 can be one or more of various types of entities such as, for example, one or more computers, that can provide location information of one or more RF tag readers (such as, for example, the RF tag reader 115, the RF tag reader 120, and the RF tag reader 125) to the server 130 for generating enhanced hybrid location information of one or more RF tags (such as, for example, the RF tag 110). The enhanced hybrid location information may then be provided by the enhanced hybrid location information system 135 to one or more of various entities such as, for example, the client entity 140. In an example embodiment, the supplementary source of RF tag reader(s) location information source 150 can be crowd-sourced and/or cloud-based (as indicated by cloud 145).

An example method to generate enhanced hybrid location information will now be described. Hybrid location information may be generally described as including location information of an RF tag obtained by use of one or more RF tag readers and further including location information of the RF tag reader(s). In the illustrated example, the RF tag reader 115, the RF tag reader 120, and the RF tag reader 125 exemplify three stationary RF tag readers that are used to obtain location information of the RF tag 110.

Each of the three tag readers can perform a tag reading operation such as described below with reference to the RF tag reader 115. The RF tag reader 120 and the RF tag reader 125 can perform tag reading operations either concurrently with the RF tag reader 115 or at different times.

In an example tag reading operation, the RF tag reader 115 establishes RF communications with the RF tag 110. The RF tag 110 can be either a passive RF tag or an active RF tag. A passive RF tag harvests electrical power from RF signals received from an RF tag reader. The electrical power is used for operating circuitry contained in the passive RF tag. An active RF reader has an in-built power source (typically, a battery) for operating circuitry contained in the active RF tag and does not depend upon power harvested from RF signals.

The RF tag 110 is typically a low cost item that typically includes a small memory in which a limited amount of information can be stored (such as, for example, a number, an identification code, or a label). The RF tag 110 can further include logic circuitry configured to support communications with the RF tag reader 115 via RF signals.

One example factor that can define a communication range between the RF tag 110 and an RF tag reader such as the RF tag reader 115, is an RF signal transmission power of the RF tag reader 115. More specifically, the communication range (distance traversed by a transmitted RF signal) can be directly related to the amount of power in the transmitted RF signal. Other example factors can include RF receiver sensitivity in the RF tag 110, RF receiver sensitivity in the RF tag reader 115, operating RF frequencies, and RF modulation techniques used. For example, a passive RF tag and an RF tag reader operating in the UHF frequencies (300 MHz to 3 GHz, for example) can operate over communication ranges ranging from a few centimeters to as far as 12 meters. An active RF tag and RF tag reader operating in the same UHF frequencies may achieve communication ranges of 100 meters or more.

The RF tag reader 115 can obtain some or all of the information contained in the memory of the RF tag 110 by reading the RF tag 110. The information may be used for purposes such as for identifying the RF tag 110 when performing a location determination operation that is based on obtaining range information between the RF tag reader 115 and the RF tag 110.

In an example location determination operation, range information between the RF tag reader 115 and the RF tag 110 is obtained by the RF tag reader 115 based on use of received signal strength indication (RSSI) measurement techniques.

In an example location determination operation, range information between the RF tag reader 115 and the RF tag 110 is obtained by the measurement of time that RF signals travel over the air. The RF tag reader 115 starts the operation by transmitting an RF ranging signal. The RF tag 110 receives the RF ranging signal and transmits a response signal back to the RF tag reader 115. The RF tag reader 115 measures an amount of time that has elapsed between transmission of the ranging signal and receiving of the response signal, and calculates a separation distance (which can be referred to herein as a range) based on the elapsed amount of time and a travel speed of the RF signal (speed of light). In some cases, compensation or offsetting of some types of time delays included in the elapsed amount of time may be carried out. For example, an amount of signal delay incurred in the RF tag 110 may be taken into account when calculating the range.

The range information determined by the RF tag reader 115 (referred to herein by the label—a first ranging measurement) may then be transmitted by the RF tag reader 115 to the server 130 via any one or more of various types of communications (cellular, Wi-Fi, BLE, UWB, etc.).

The example location determination operation described above further involves similar operations conducted by the RF tag reader 120 for obtaining a second ranging measurement (separation distance between the RF tag 110 and the RF tag reader 120) and by the RF tag reader 125 for obtaining a third ranging measurement (separation distance between the RF tag 110 and the RF tag reader 125). The RF tag reader 120 transmits the second ranging measurement to the server 130 via any of various types of communications that can be similar to, or different than, the communications used by the RF tag reader 115. The RF tag reader 125 transmits the third ranging measurement to the server 130 via any of various types of communications that can be similar to, or different than, the communications used by the RF tag reader 115 and/or the RF tag reader 120.

The server 130 may determine a location of the RF tag 110 based on evaluating the first ranging measurement received from the RF tag reader 115, the second ranging measurement received from the RF tag reader 120, and the third ranging measurement received from the RF tag reader 125. More particularly, the server 130 may determine a location of the RF tag 110 based on performing a trilateration procedure by use of the three ranging measurements.

Trilateration may be generally described as a procedure of determining a position of an object by measuring distances to points at known coordinates. In this case, the known coordinates are provided in the form of three stationary devices, more specifically, in the form of the RF tag reader 115, the RF tag reader 120, and the RF tag reader 125. In an example embodiment, location coordinates where the three devices are stationed can be provided by each of the three devices to the server 130. More particularly, the RF tag reader 115 can determine its own location coordinates by performing any of various types of location determination operations based on technologies such as global navigation satellite system (GNSS), Wi-Fi, Bluetooth® Low Energy (BLE), and ultra-wide band (UWB). The RF tag reader 120 and the RF tag reader 125 can perform similar operations.

In an example scenario, the RF tag reader 115 can determine its own location, which can be referred to as obtaining a position fix, by using a GNSS positioning procedure. The RF tag reader 115 can be, for example, a part of a smartphone or a navigation aid device that includes a GNSS system configured to receive signals from one or more GNSS satellites. A GNSS positioning procedure is typically based on trilateration/multilateration, which is a method of determining position by measuring distances to points at known coordinates. In general, the determination of the position of the RF tag reader 115 in three dimensions may rely on a determination of the distance between the RF tag reader 115 and four or more satellite vehicles. Three-dimensional (3D) coordinates may be based on a coordinate system (e.g., XYZ coordinates; latitude, longitude, and altitude; etc.) centered at the earth's center of mass. A distance between each satellite vehicle and the RF tag reader 115 may be determined using precise measurements made by the RF tag reader 115 of a difference in time from when a RF signal is transmitted from the respective satellite vehicle to when it is received at the RF tag reader 115. To help ensure accuracy, not only does the RF tag reader 115 need to make an accurate determination of when the respective signal from each satellite vehicle is received, but many additional factors need to be considered and accounted for. These factors include, for example, clock differences at the RF tag reader 115 and satellite vehicle (e.g., clock bias), a precise location of each satellite vehicle at the time of transmission (e.g., as determined by the broadcast ephemeris), the impact of atmospheric distortion (e.g., ionospheric and tropospheric delays), and the like.

To perform a traditional GNSS position fix, the RF tag reader 115 can use code-based positioning to determine its distance to each satellite vehicle based on a determined delay in a generated pseudorandom binary sequence received in the RF signals received from each satellite, in consideration of the additional factors and error sources previously noted. With the distance and location information of the satellite vehicles, the RF tag reader 115 can then determine a position fix for its location. This position fix may be determined, for example, by a Standalone Positioning Engine (SPE) executed by one or more processors of the RF tag reader 115. However, code-based positioning is relatively inaccurate and, without error correction, is subject to errors. Even so, code-based GNSS positioning can provide a positioning accuracy for the RF tag reader 115 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellite vehicles observed by the RF tag reader 115 can be mitigated or canceled based on similar carrier-based ranging of the satellite vehicles using a highly accurate GNSS receiver at a base station of a cellular network. The base station is located at a known location. These measurements and the base station's location can be provided to the RF tag reader 115 for error correction. This position fix may be determined, for example, by a Precise Positioning Engine (PPE) executed by one or more processors of the RF tag reader 115. More specifically, in addition to the information provided to a Standalone Positioning Engine (SPE), the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters).

Multi-frequency GNSS receivers use satellite signals from different GNSS frequency bands to determine desired information such as pseudoranges, position estimates, and/or time. One or more of the satellite vehicles may transmit multiple satellite signals in different GNSS frequency bands, such as L1, L2, and/or L5 frequency bands. Various receiver configurations may be used to receive satellite signals. For example, the RF tag reader 115 may use separate receive chains for different frequency bands. As another example, the RF tag reader 115 may use a common receive chain for multiple frequency bands that are close in frequency, for example L2 and L5 bands. As another example, the RF tag reader 115 may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As another example, the RF tag reader 115 can determine its own location by performing a multilateration procedure based on communications with multiple cellular communication towers. An example multilateration procedure that is typically referred to as a trilateration procedure, works on the general principle that a location of an object can be determined based on three individual distances between the object and three reference points (such as, for example, between a cell phone and three cell towers). The trilateration procedure can involve, for example, a time of flight (TOF) measurement or a time delay-to-distance conversion measurement that is based on cellular signal communications.

As another example, the RF tag reader 115 can determine its own location based on communications with a server of a location information provider. The server, which can be cloud-based (as indicated by cloud 145), can provide the location based on use of a database that is made accessible to the RF tag reader 115.

As another example, the RF tag reader 115 can determine its own location based on communications with short-range devices such as, for example, Wi-Fi devices, ultra-wide band (UWB) devices, Bluetooth® devices, infrared devices, near field communication (NFC) devices, and Zigbee® devices. In an example procedure, the RF tag reader 115 can communicate with a Wi-Fi access point (AP) to obtain geospatial information of the Wi-Fi AP and can provide the geospatial information of the Wi-Fi AP to a location server. The location server, which can be cloud-based, can determine a location of the RF tag reader 115 based on the geospatial information of the Wi-Fi AP.

As indicated above, the first ranging measurement determined by the RF tag reader 115 with reference to the RF tag 110 is transmitted by the RF tag reader 115 to the server 130 via any one or more of various types of communications (cellular, Wi-Fi, UWB, etc.). The RF tag reader 115 further transmits its own location information (determined by one or more of the various ways described above) to the server 130 via any one or more of various types of communications (cellular, Wi-Fi, UWB, etc.). In one embodiment, the location information may be transmitted to the server 130 in the form of raw measurements obtained by the RF tag reader 115, such as, for example, unprocessed range measurement obtained via communications with one or more Wi-Fi devices, UWB devices, Bluetooth® devices, infrared devices, NFC devices, and/or Zigbee® devices

As also indicated above, the server 130 represents one or more computers that include an enhanced hybrid location information system 135. The enhanced hybrid location information system 135 can store and/or derive enhanced hybrid location information associated with one or more RF tags such as, for example, the RF tag 110, and provide various types of services based on the enhanced hybrid location information.

In the illustrated example configuration, the server 130 may determine/derive a location of the RF tag 110 by using a combination of the first ranging measurement received from the RF tag reader 115, the second ranging measurement received from the RF tag reader 120, and the third ranging measurement received from the RF tag reader 125. More particularly, the server 130 may derive a location of the RF tag 110 based on performing a trilateration procedure by use of the three ranging measurements. The server 130 may then generate enhanced hybrid location information based on the information pertaining to the RF tag 110 and the location information of each of the RF tag reader 115, the RF tag reader 120, and the RF tag reader 125. In one embodiment, the location information of the RF tag 110 that is determined by the server 130 based on the three ranging measurements can be provided to a third party entity (such as, for example, the client entity 140). In another embodiment, the location information of the RF tag 110 can be the three ranging measurements. In this case, the three ranging measurements can be provided to a third party entity (such as, for example, the client entity 140) to enable the third party entity to determine a location of the RF tag 110 based on use of a trilateration procedure. In another embodiment, some, or all, of the enhanced hybrid location information that is provided to a third party entity can include the location information of the RF tag 110, the three ranging measurements, and/or the location information of the three RF tag readers.

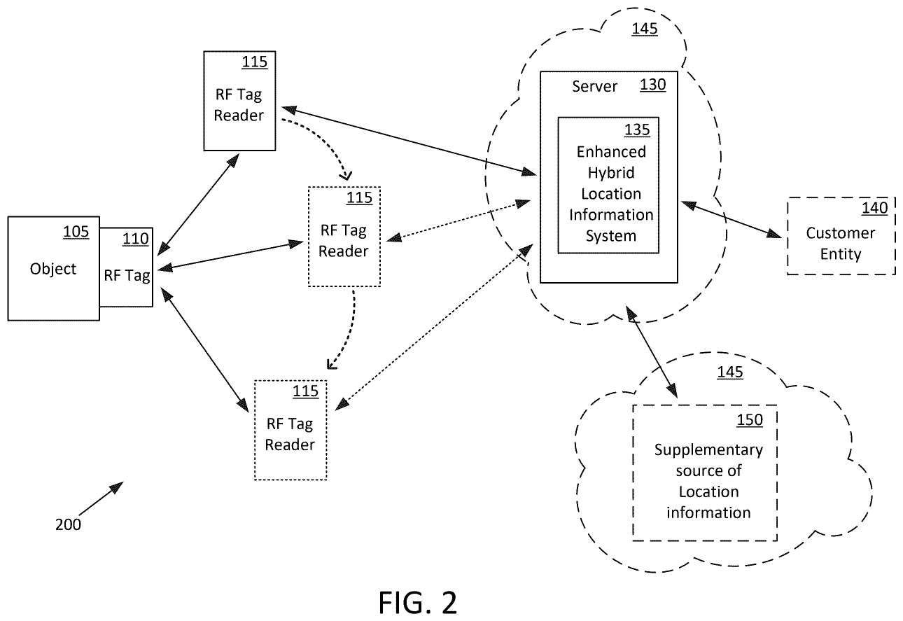

FIG. 2 illustrates a simplified version of an example location services system 200 according to a second embodiment. The description provided above with reference to the location services system 100 is equally applicable to the location services system 200 in all aspects other than with reference to the use of three separate RF tag readers for obtaining the three ranging measurements that can be used by the server 130 to obtain location information of the RF tag 110. In this second embodiment, the three ranging measurements are obtained by a single RF tag reader, which, in the illustrated example configuration is the RF tag reader 115. More particularly, the RF tag reader 115 in this case is a mobile device, such as, for example, a hand-held RF tag reader or a smartphone that includes an RF tag reader.

The RF tag reader 115 obtains a first ranging measurement when located at a first spot, a second ranging measurement when located at a second spot, and a third ranging measurement when located at a third spot. The RF tag reader 115 transmits the first, second, and third ranging measurements to the server 130 via any of various types of communications. In one embodiment, the first ranging measurement is transmitted by the RF tag reader 115 to the server 130 when the RF tag reader 115 is located at the first spot, the second ranging measurement is transmitted by the RF tag reader 115 to the server 130 when the RF tag reader 115 is located at the second spot, and the third ranging measurement is transmitted by the RF tag reader 115 to the server 130 when the RF tag reader 115 is located at the third spot. In another embodiment, the RF tag reader 115 may transmit all three range measurements after obtaining all three range measurements, either when located at the third spot or when located at another spot to which the RF tag reader 115 may have moved to, from the third spot.

In the illustrated example configuration, the server 130 and/or the RF tag reader 115 may determine/derive a location of the RF tag 110 by using a combination of the first, second, and third ranging measurements. In an example scenario, the RF tag reader 115 may determine a location of the RF tag 110 based on the first, second, and third ranging measurements. The determination may be made either when the RF tag reader 115 is at the third location or has moved to a different location after obtaining the third ranging measurement. The server 130 may determine a location of the RF tag 110 based on performing a trilateration procedure by use of the three ranging measurements received from the RF tag reader 115.

In an example implementation, the RF tag reader 115 may provide location information of each of the first spot, the second spot, and the third spot to the server 130 based on performing location determination procedures, such as described above (GNSS, cellular, Wi-Fi, etc.), at each of the first spot, the second spot, and the third spot.

In another example implementation, the RF tag reader 115 may select the three spots based on location information either known to, or selected by, the RF tag reader 115. For example, the RF tag reader 115 may select the three spots based on location information of the three spots stored in a memory/database of the RF tag reader 115. In one case, the location information of the three spots stored in a memory/database of the RF tag reader 115 may be historic information obtained by the RF tag reader 115.

In another example implementation, the server 130 may designate to the RF tag reader 115, the first, second, and third spots, based on any of various criteria such as, for example, based on location information of the first, second, and third spots obtained from one or more other RF tag readers.

The server 130 may generate enhanced hybrid location information based on the information pertaining to the RF tag 110 and the location information of each of the three spots from which the RF tag reader 115 obtains the three range measurements.

In an example embodiment, a timestamp may be provided for indicating a time at which a location determination procedure is performed at any of one or more spots. In the example implementation described above, timestamps associated with the location determination procedures performed at the first spot, the second spot, and the third spot may be used for various purposes such as, for example, to identify a time sequence associated with the location determination procedures and/or to evaluate the timestamps for other metrics such as, for example, to determine a freshness of the location determination procedures (out-of-date measurements, currently valid measurements, etc.).

In an example embodiment, the location information of the RF tag 110 that is determined by the server 130 based on the three ranging measurements can be provided to a third party entity (such as, for example, the client entity 140). In another embodiment, the location information of the RF tag 110 can be the three ranging measurements. In this case, the three ranging measurements can be provided to a third party entity (such as, for example, the client entity 140) to enable the third party entity to determine a location of the RF tag 110 based on use of a trilateration procedure. In another embodiment, some, or all, of the enhanced hybrid location information that is provided to a third party entity can include the location information of the RF tag 110, the three ranging measurements, and/or the location information of the three spots from which the range measurements were obtained.

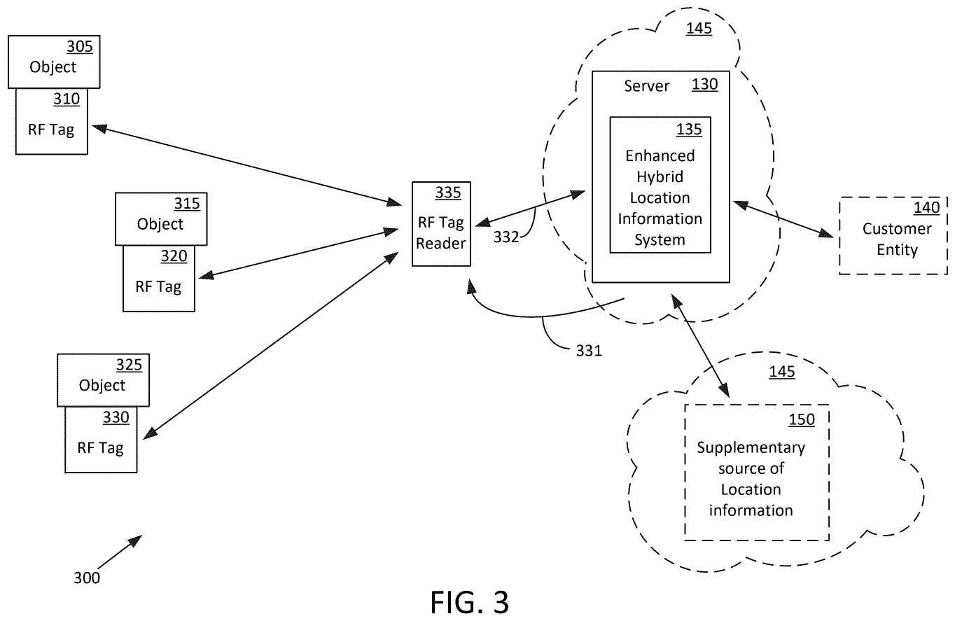

FIG. 3 illustrates a simplified version of an example location services system 300 according to a third embodiment. In this third embodiment, an RF tag reader 335 obtains a first ranging measurement corresponding to a first RF tag (RF tag 310 attached to an object 305), a second ranging measurement corresponding to a second RF tag (RF tag 320 attached to an object 315), and a third ranging measurement corresponding to a third RF tag (RF tag 330 attached to an object 325).

The RF tag 310 is stationed at a first spot, the RF tag 320 is stationed at a second spot, and the third RF tag 330 is stationed at a third spot. For example, each of the objects to which the RF tags are attached may be stationary objects (door frame, conveyer belt, etc.).

The RF tag reader 335 transmits the first, second, and third ranging measurements to the server 130 via any one or more of various types of communications (cellular, Wi-Fi, UWB, etc.). The server 130 determines a location of the RF tag reader 335 based on the first, second, and third ranging measurements and based on apriori knowledge of the locations of the RF tag 310, the RF tag 320, and the RF tag 330 which operate as anchor devices for performing a trilateration position identification operation.

In an example embodiment, the location of the RF tag reader 335 may be determined by the RF tag reader 335 itself, rather than by the server 130. In this embodiment, the server 130 conveys location information of the RF tag 310, the RF tag 320, and the RF tag 330 to the RF tag reader 335 via a communication link 331 (cellular, Wi-Fi, UWB, etc.). The RF tag reader 335 then uses this location information of the three stationary RF tags to determine its own location based on using the three ranging measurements to perform a trilateration operation. The location information of the RF tag reader 335 may be conveyed by the RF tag reader 335 to the server 130 via the communication link 332.

The server 130 may generate enhanced hybrid location information based on the information pertaining to the RF tag reader 335, the location information of the RF tag 310, the location information of the RF tag 320, and/or the location information of the RF tag 330.

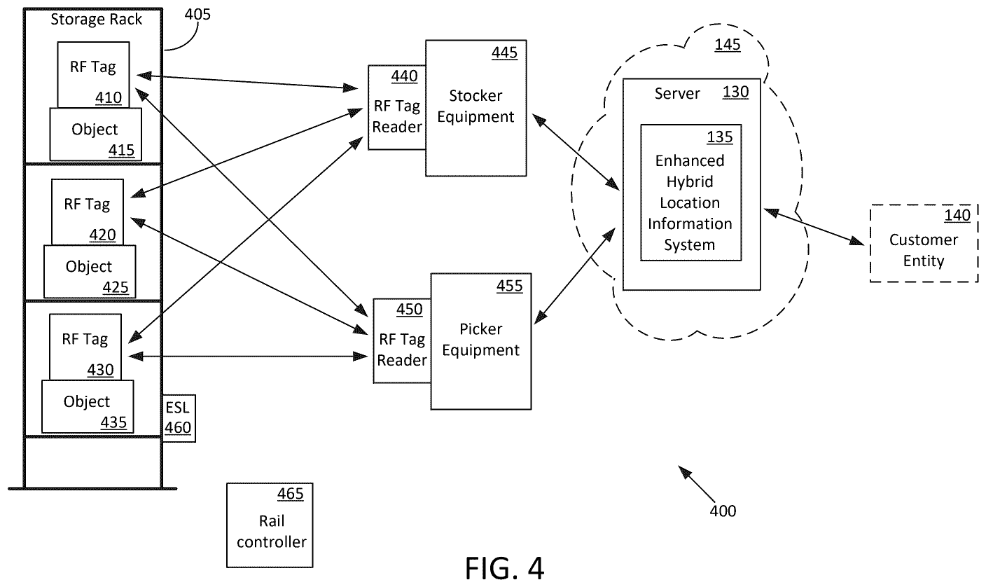

FIG. 4 illustrates a simplified version of an example location services system 400 according to a fourth embodiment. In this fourth embodiment, an RF tag reader 440 that is attached to an example stocker equipment 445 (truck, cart, forklift, etc.) obtains a first ranging measurement corresponding to a first RF tag (RF tag 410 attached to an object 415), a second ranging measurement corresponding to a second RF tag (RF tag 420 attached to an object 425), and a third ranging measurement corresponding to a third RF tag (RF tag 430 attached to an object 435). The RF tag reader 440 transmits the three ranging measurements and position information of the RF tag reader 440, to the server 130. The position information of the RF tag reader 440 may be obtained by the RF tag reader 440 based on performing location determination procedures, such as described above (GNSS, cellular, Wi-Fi, etc.).

One or more other RF tag readers, such as, for example, an RF tag reader 450 that is attached to an example picker equipment 455 (truck, cart, forklift, etc.) similarly obtains a first ranging measurement corresponding to the first RF tag (RF tag 410 attached to an object 415), a second ranging measurement corresponding to the second RF tag (RF tag 420 attached to an object 425), and a third ranging measurement corresponding to the third RF tag (RF tag 430 attached to an object 435). The RF tag reader 450 transmits the three ranging measurements and position information of the RF tag reader 450 to the server 130. The position information of the RF tag reader 450 may be obtained by the RF tag reader 450 based on performing location determination procedures, such as described above (GNSS, cellular, Wi-Fi, etc.).

The ranging measurements may be used by the server 130 (and/or by one or both of the RF tag reader 440 and the RF tag reader 450) to obtain location information of the RF tag 410, the RF tag 420, and/or the RF tag 430. In an example embodiment, location information of the RF tag 410, the RF tag 420, and/or the RF tag 430 determined by use of the RF tag reader 440 may be used to determine the location of the object 415, the object 420, the object 425, and the object 435 respectively. The location information of such objects can, for example, assist an operator of the stocker equipment 445 to access and to move the objects as deemed fit.

The server 130 may generate enhanced hybrid location information based on location information pertaining to the RF tag 410, the RF tag 420, the RF tag 430, the RF tag reader 440, and the RF tag reader 450, in various ways as described above with reference to other embodiments.

In an example implementation, the location information pertaining to the RF tag 410, the RF tag 420, the RF tag 430 may be determined by the server 130 based on using the ranging measurements received from one or both of the RF tag reader 440 and the RF tag reader 450 in the manner described above. In another example implementation, the location information pertaining to the RF tag 410, the RF tag 420, the RF tag 430 may be determined by one or both of the RF tag reader 440 and the RF tag reader 450 based on using the ranging measurements in the manner described above.

In an example scenario, the object 415, the object 425, and the object 435 may be items stored in a storage rack 405 of a business (a retail store, a warehouse, a factory, a manufacturing facility etc.). Traditionally, RF tags attached to such objects may be used for purposes such as tracking, providing pricing information, and inventory. The various example embodiments described herein enable identifying and utilizing location information associated with the various objects. For example, various example embodiments described herein can enable the client entity 140 to not only perform such traditional operations but to also use the enhanced hybrid location information provided by the server 130 to locate, for example, the object 415 that is placed on a top shelf of the storage rack 405. In an example implementation, enhanced hybrid location information derived by use of the multiple RF tags in the manner described herein may be used to supplement, complement, or replace information associated with electronic shelf labels (ESLs) used in traditional practice. In an example scenario, an RF tag that is configured to perform operations described herein may be either attached to an object or may be integrated into an ESL 460. The ESL 460 may be attached to the storage rack 405. In an example scenario, the ESL 460 may be configured to communicate with a rail controller 465 configured to operate one or more rails that may be included in the storage rack 405 for moving objects placed upon the storage rack 405. The ESL 460 and/or the rail controller 465 may include hardware and software configured to obtain measurements indicative of one or more of the RF tags shown attached to the various objects. In an example embodiment, the ESL 460 and/or the rail controller 465 can be, what are referred to herein, as stationary RF tag readers.

The RF tag reader 440 and/or the RF tag reader 450 can provide the ranging measurements/location information of the various RF tags and location information of the RF tag reader 440 and/or the RF tag reader 450 at various intervals (intermittently, periodically, randomly, on-demand, etc.) to enable the server 130 to update/edit/correct the enhanced hybrid location information. For example, the RF tag reader 440 may provide ranging measurements of the three example RF tags, at each instant when the stocker equipment 445 is in the vicinity of the storage rack 405. In an example scenario, an operator of the stocker equipment 445 and/or the picker equipment 455 may be provided with the enhanced hybrid location information by the server 130 for purposes such as identifying a location of one or more objects, stocking additional objects, and/or retrieving one or more objects.

In an example embodiment, the RF tag reader 440 and/or the RF tag reader 450 may be included in portable devices, such as, for example, smartphones that are carried by the operators.

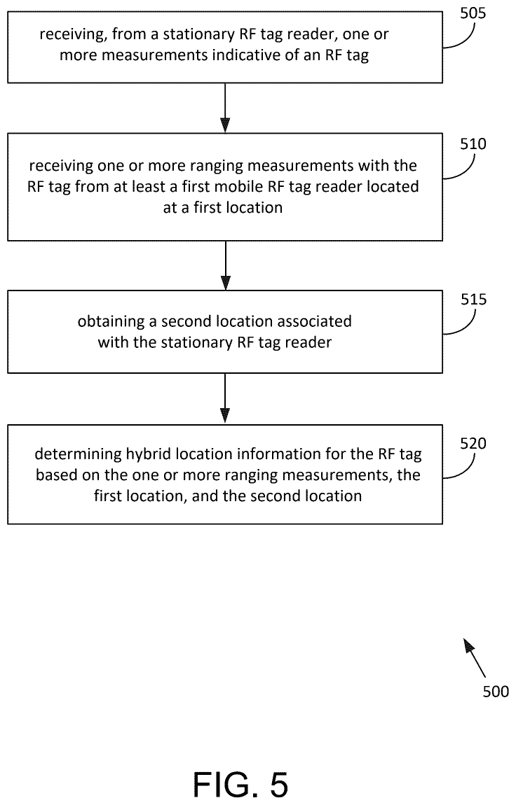

FIG. 5 shows a flowchart 500 of a method performed by a server for providing location services. Means for performing the functionality illustrated in one or more of the blocks of the flowchart 500 may be performed by hardware and/or software components of a server such as described herein with reference to the server 130.

At block 505, the functionality can include receiving, from a stationary RF tag reader, one or more measurements indicative of an RF tag. In an example implementation, the one or more measurements indicative of the RF tag may be obtained by a stationary RF tag reader such as, for example, the electronic shelf label (ESL) 460 and/or the rail controller 465 described above with reference to FIG. 4.

At block 510, the functionality can include receiving one or more ranging measurements with the RF tag from at least a first mobile RF tag reader located at a first location. In an example implementation, the one or more ranging measurements may be made by a plurality of RF tag readers, each located at a respective location of the plurality of locations. An example embodiment is illustrated in FIG. 1, where three RF tag readers obtain ranging measurements with reference to the RF tag 110, from three different spots. In another example embodiment, the ranging measurements are made by a single RF tag reader at each of the plurality of locations at different times. This embodiment is illustrated in FIG. 2, where an RF tag reader 115 moves from a first spot to a second spot, and to a third spot for obtaining ranging measurements with reference to the RF tag 110.

At block 515, the functionality can include obtaining a second location associated with the stationary RF tag reader. In an example scenario, the stationary RF tag reader can be an ESL or a rail controller such as the ESL 460 and the rail controller 465 illustrated in FIG. 4 and described above. In this example, the second location associated with the ESL 460 and the rail controller 465 can correspond to a location of the storage rack 405.

At block 520, the functionality can include determining hybrid location information for the RF tag based on one or more ranging measurements, the first location, and the second location. In an example scenario, the location information for the RF tag 410 for example (shown in FIG. 4) may be based on ranging measurements obtained by the RF tag reader 440 and/or the RF tag reader 450, the location of the RF tag reader 440 and/or the RF tag reader 450, and the location of the stationary RF tag reader (ESL 460, for example).

In an example embodiment, enhanced hybrid location information may be derived based on, for example, complementing hybrid location information for the RF tag 410 with location information of the object 415, wherein the location information of the object 415 is based on the RF tag 410 attached to the object 415.

The enhanced hybrid location information may be provided, for example, to an operator of the stocker equipment 445 to access and to perform various operations including operations associated with one or more of the objects on the storage rack 405. In an example scenario, the enhanced hybrid location information may be used to track and/or to identify a location of the object 415 at any given time.

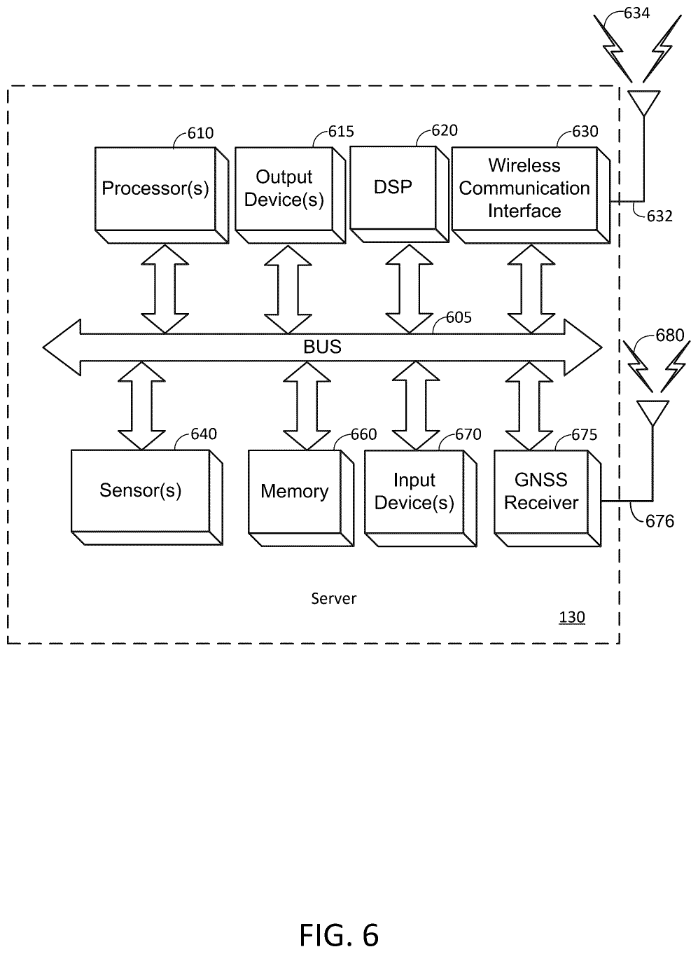

FIG. 6 shows a block diagram of a server 130 in accordance an embodiment of the disclosure. As indicated above, the server 130 may implement the enhanced hybrid location information system 135. It should be noted that FIG. 6 is meant only to provide a generalized illustration of various components, any or all of which may be utilized as appropriate. Furthermore, as previously noted, the functionality of the enhanced hybrid location information system 135 discussed herein may be executed by one or more of the hardware and/or software components illustrated in FIG. 6.

The server 130 is shown comprising hardware elements that can be electrically coupled via a bus 605 (or may otherwise be in communication, as appropriate). The hardware elements may include a processor(s) 610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 610 may comprise one or more processing units, which may be housed in a single integrated circuit (IC) or multiple ICs. As shown in FIG. 6, some embodiments may have a separate DSP 620, depending on desired functionality. Communication operations based on wireless communication may be provided in the processor(s) 610 and/or in the wireless communication interface 630 (discussed below). The server 130 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The server 130 may also include the wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the server 130 to communicate and/or perform various operations as described in the embodiments above, with respect to cellular technologies, Wi-Fi technologies, and UWB technologies, for example. The wireless communication interface 630 may permit data and signaling to be communicated (e.g., transmitted and received) with various types of nodes of various types of networks, various computer systems, and/or any other electronic devices. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

As noted above, the server 130 may implement the enhanced hybrid location information system 135. The enhanced hybrid location information system 135 may comprise the hardware and/or software elements described with respect to FIG. 6.

Some of the enhanced hybrid location information system 135 may be implemented by use of components such as, for example, the processor(s) 610, the memory 660, the GNSS receiver 675, and the wireless communication interface 630. That said, embodiments are not so limited. Alternative embodiments may implement some or all of the enhanced hybrid location information system 135 separate from the wireless communication interface 630.

For example, in one embodiment, the processor(s) 610 may execute instructions stored in the memory 660 for performing operations associated with the enhanced hybrid location information system 135, including, for example, determining a position of the RF tag 110 based on the ranging measurements provided by the three stationary RF tag readers (RF tag reader 115, RF tag reader 120, and RF tag reader 125 as illustrated in FIG. 1), and deriving enhanced hybrid location information that includes location information related to the RF tag 110 and the three RF tag readers. In an example implementation, the enhanced hybrid location information may be stored in the memory 660. The processor(s) 610 may provide this information to the client entity 140 (upon receiving a request from the client entity 140, for example). As indicated above, the client entity 140 can represent one or more computers operated by one or more customers seeking location services and/or other services offered by the enhanced hybrid location information system 135. In an example implementation, the client entity 140 may use the enhanced hybrid location information provided by the enhanced hybrid location information system 135 of the server 130 for purposes of performing a tracking service, an inventory service, a customer service, and/or a product development service, for example.

In another embodiment, the processor(s) 610 may execute instructions stored in the memory 660 for performing operations associated with deriving, storing, and providing enhanced hybrid location information system (in the manner described above) by performing operations such as determining a position of the RF tag 110 based on the ranging measurements provided by the RF tag reader 115 moving from a first spot to two other spots as described above with reference to FIG. 2.

In another embodiment, the processor(s) 610 may execute instructions stored in the memory 660 for performing operations associated with deriving, storing, and providing enhanced hybrid location information system (in the manner described above) by performing operations described above with reference to FIG. 3 such as determining a location of the RF tag reader 335 based on the first, second, and third ranging measurements and based on apriori knowledge of the locations of the RF tag 310, the RF tag 320, and the RF tag 330.

In another embodiment, the processor(s) 610 may execute instructions stored in the memory 660 for performing operations associated with deriving, storing, and providing enhanced hybrid location information system (in the manner described above) by performing operations described above with reference to FIG. 4 such as determining a location of each of a plurality of RF tags attached to objects located on the example storage rack 405.

Depending on desired functionality, the wireless communication interface 630 may comprise a separate receiver and transmitter, or any combination of transceivers, transmitters, and/or receivers to communicate with various RF tag readers (such as, for example RF tag reader 115, RF tag reader 120, and RF tag reader 125) and terrestrial transceivers as well as satellites. The term “transceiver” as used herein can refer to a component that can be a transmitter, a receiver or can have both functionalities, but is not limited to requiring both. In some implementations, a transceiver can be an integrated component that includes both a transmitter and a receiver. In some implementations, a transceiver can be provided in the form of two distinct components—a transmitter and a receiver.

The server 130 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The server 130 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain location-related measurements and/or other information.

Embodiments of the server 130 may also include a Global Navigation Satellite System (GNSS) receiver 675 capable of receiving signals 680 from one or more GNSS satellites using an antenna 676 (which could be the same as antenna 632). Positioning based on GNSS signal measurement can be utilized to complement and/or incorporate the techniques described herein. The GNSS receiver 675 can extract a position of the server 130, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 675 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 675 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 610, DSP 620, and/or a processor within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 610 or DSP 620.

The server 130 may further include and/or be in communication with a memory 660. The memory 660 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the server 130 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the server 130 (and/or processor(s) 610 or DSP 620 within server 130). In some embodiments, then, such code and/or instructions can be used to configure and/or adapt a general-purpose computer (or other device) to perform one or more operations in accordance with the described methods.

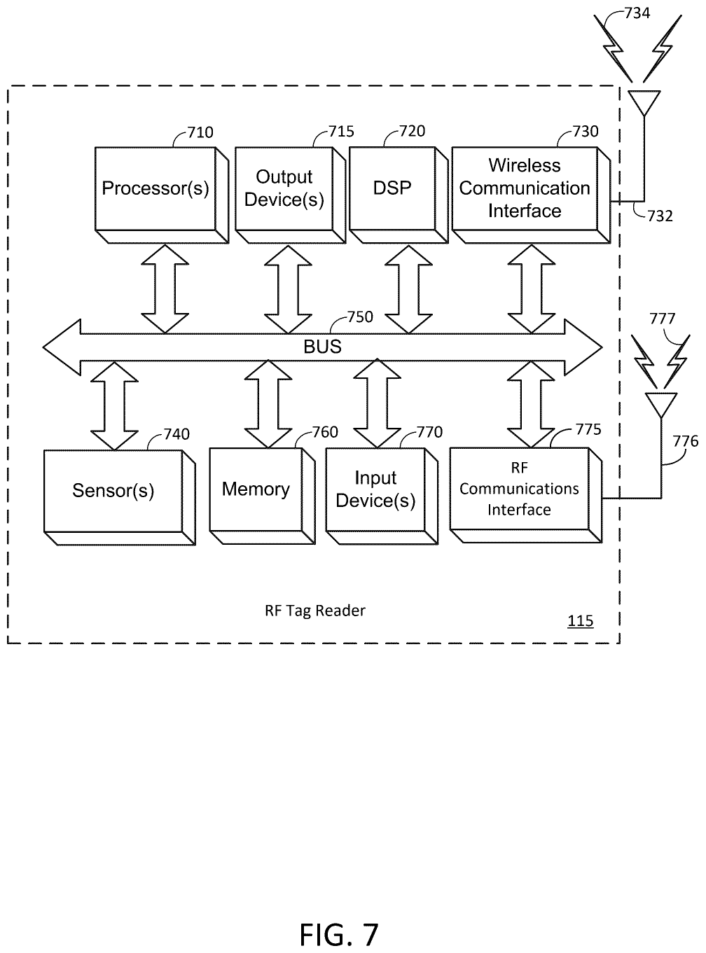

FIG. 7 is a block diagram of some example components that can be included in the RF tag reader 115 in accordance an embodiment of the disclosure. The description below with respect to the RF tag reader 115 is equally applicable to other tag readers such as, for example, the RF tag reader 120 and the RF tag reader 125 described herein. As indicated above the RF tag reader can be a dedicated RF scanning device or can be included in devices such as, for example, a smartphone, a personal computer, or a device mounted on a fixture.

The RF tag reader 115 may be capable of performing some or all of the functionality described in the method shown in FIG. 5 and in the example systems illustrated in FIGS. 1-4. It should be noted that FIG. 7 is meant only to provide a generalized illustration of various components, any or all of which may be utilized as appropriate.

The RF tag reader 115 is shown comprising hardware elements that can be electrically coupled via a bus 750 (or may otherwise be in communication, as appropriate). The hardware elements may include a processor(s) 710, which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 7, some embodiments may have a separate DSP 720, depending on desired functionality. The RF tag reader 115 also can include one or more input devices 770 (depending, for example, on the nature of the device into which the RF tag reader 115 is incorporated), such as, for example, a keyboard, display, mouse, microphone, button(s), dial(s), switch(es), and/or the like; and one or more output devices, such as, for example, a display, light emitting diode (LED), speakers, and/or the like. The RF tag reader 115 also can include one or more output devices 715, which can include without limitation one or more displays (e.g., touch screens), light emitting diodes (LEDs), speakers, and/or the like.

The RF tag reader 115 might also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the RF tag reader 115 to communicate with other devices such as, for example, the server 130. The wireless communication interface 730 may permit data and signaling to be communicated (e.g., transmitted and received) to various network components, computer systems, and/or other electronic devices described herein. The communication can be carried out via one or more wireless communication antenna(s) 732 that send and/or receive wireless signals 734. According to some embodiments, one or more wireless communication antenna(s) 732 may comprise one or more antenna arrays, which may be capable of beamforming.

The RF tag reader 115 might also include an RF communications interface 775, which may comprise without limitation a network card, an infrared communication device, a wireless communication device, and/or a chipset, and/or the like, which may enable the RF tag reader 115 to communicate with other devices such as, for example, the RF tag 110 via RF signals 777. According to some embodiments, one or more wireless communication antenna(s) 776 may comprise one or more antenna arrays, which may be capable of beamforming.

The RF tag reader 115 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain location-related measurements and/or other information.

Sensor(s) 740 may also be used, for example, to detect an object and various characteristics associated with the object.

In many embodiments, the RF tag reader 115 may further comprise a memory 760. The memory 760 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the RF tag reader 115 also may comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the RF tag reader 115 (and/or processor(s) 710 or DSP 720 within RF tag reader 115). In some embodiments, then, such code and/or instructions can be used to configure and/or adapt a general-purpose computer (or other device) to perform one or more operations in accordance with the described methods.

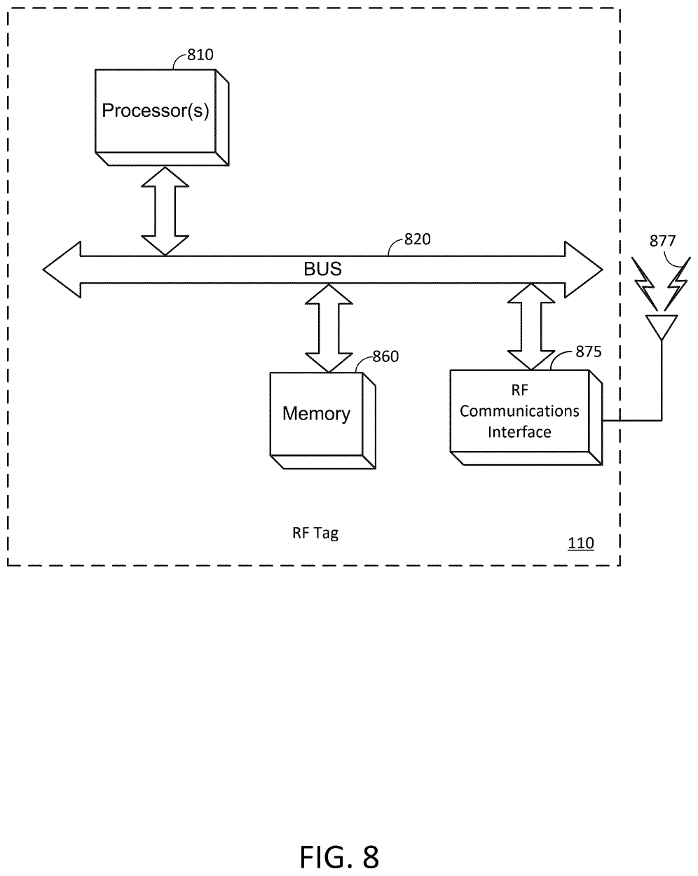

FIG. 8 is a block diagram of some example components that can be included in the RF tag 110 in accordance an embodiment of the disclosure. As indicated above the RF tag can be attached to an object or can be incorporated inside an object. The RF tag 110 may be capable of performing some or all of the tag-related functionalities described herein, such as those described above with respect to FIGS. 1-5. It should be noted that FIG. 8 is meant only to provide a generalized illustration of various components, any or all of which may be utilized as appropriate.

The RF tag 110 might include an RF communications interface 875, which may enable the RF tag 110 to communicate with other devices such as, for example, the RF tag reader 115, via RF signals 877.

The RF tag 110 is shown comprising hardware elements that can be electrically coupled via a bus 820 (or may otherwise be in communication, as appropriate). The hardware elements may include a processor(s) 810, which can include without limitation one or more general-purpose processors, one or more special-purpose processors (such as digital signal processor (DSP) chips, application-specific integrated circuits (ASICs), and/or the like), and/or other processing structure or means.

In many embodiments, the RF tag 110 may further comprise a memory 860. The memory 860 can include, without limitation, a solid-state storage device, such as a random-access memory (RAM), and/or a read-only memory (ROM), which can be programmable, flash-updateable, and/or the like. Such storage devices may be configured to implement any appropriate data stores.

The memory 860 of the RF tag 110 also may comprise software elements (not shown in FIG. 8), including one or more application programs, which may comprise computer programs provided by various embodiments, and/or may be designed to implement functionalities described herein. Merely by way of example, one or more functionalities may be implemented as code and/or instructions in memory 860 that are executable by the processor(s) 810. Furthermore, the RF tag 110 is typically a low cost item and the memory 860 can be a small memory in which a limited amount of information can be stored (such as, for example, a number, an identification code, or a label).

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media.

Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1 A method performed by a server for providing location services, the method comprising receiving, from a stationary RF tag reader, one or more measurements indicative of an RF tag; receiving one or more ranging measurements with the RF tag from at least a first mobile RF tag reader located at a first location; obtaining a second location associated with the stationary RF tag reader; and determining hybrid location information for the RF tag based on the one or more ranging measurements, the first location, and the second location.

Clause 2 The method of clause 1, wherein receiving, from the stationary RF tag reader, the one or more measurements indicative of the RF tag, comprises receiving, from at least one of an electronic shelf label or a rail controller, the one or more measurements indicative of the RF tag.

Clause 3 The method of either clause 1 or clause 2, wherein receiving the one or more ranging measurements with the RF tag from the at least the first mobile RF tag reader located at the first location comprises receiving the one or more ranging measurements with the RF tag from a mobile phone having RF tag reading functionality, the mobile phone located at the first location.

Clause 4 The method of clause 2, receiving, from the stationary RF tag reader, the one or more measurements indicative of the RF tag comprises receiving, from the stationary RF tag reader, one or more measurements indicative of an RFID tag, and wherein receiving the one or more ranging measurements with the RF tag from the at least the first mobile RF tag reader located at the first location comprises receiving the one or more ranging measurements with the RF tag from one of a mobile phone having RFID tag reading functionality or a hand-held RFID tag reader.

Clause 5 The method of clause 2, wherein receiving, from the stationary RF tag reader, the one or more measurements indicative of the RF tag comprises receiving the one or more measurements with the RF tag attached to a first object placed on a storage rack, via one of the electronic shelf label or the rail controller attached to the storage rack.

Clause 6 The method of any one of clause 1 through clause 5, further comprising providing the hybrid location information to a client entity.

Clause 7 The method of any one of clause 1 through clause 6, further comprising receiving additional ranging measurements with the RF tag from the first mobile RF tag reader located at a third location and a fourth location; and determining the hybrid location information for the RF tag based on the one or more ranging measurements, the first location, the second location, the third location, and the fourth location.

Clause 8 The method of clause 7, further comprising receiving, from the first mobile RF tag reader, location information of the third location and the fourth location, wherein the location information is obtained by the first mobile RF tag reader based on one or more of global navigation satellite system (GNSS) signals, cellular signals, Wi-Fi signals, ultra-wideband (UWB) signals, Bluetooth signals, or sensor measurements.

Clause 9 A server for providing location services, the server comprising at least one transceiver; at least one memory; and one or more processors communicatively coupled with the at least one memory, the one or more processors configured to receive, from a stationary RF tag reader, one or more measurements indicative of an RF tag; receive one or more ranging measurements with the RF tag from at least a first mobile RF tag reader located at a first location; obtain a second location associated with the stationary RF tag reader; and determine hybrid location information for the RF tag based on the one or more ranging measurements, the first location, and the second location.

Clause 10 The server of clause 9, wherein, to receive the one or more measurements from the stationary RF tag reader, the one or more processors are configured to receive the one or more measurements from at least one of an electronic shelf label or a rail controller.

Clause 11 The server of either clause 9 or clause 10, wherein to receive the one or more ranging measurements with the RF tag from the first mobile RF tag reader, the one or more processors are configured to receive the one or more ranging measurements with the RF tag from a mobile phone having RF tag reading functionality.

Clause 12 The server of clause 10, wherein, to receive the one or more measurements from the stationary RF tag reader, the one or more processors are configured to receive the one or more measurements from an RFID tag, and wherein to receive the one or more ranging measurements with the RF tag from the at least the first mobile RF tag reader, the one or more processors are configured to receive the one or more ranging measurements from one of a mobile phone having RFID tag reading functionality or a hand-held RFID tag reader.

Clause 13 The server of clause 10, wherein, to receive the one or more measurements indicative of the RF tag, the one or more processors are configured to receive the one or more measurements with the RF tag attached to a first object placed on a storage rack, via one of the electronic shelf label or the rail controller attached to the storage rack.

Clause 14 The server of any one of clause 1 through clause 13, wherein the one or more processors are further configured to provide the hybrid location information to a client entity.

Clause 15 The server of any one of clause 10 through clause 14, wherein, to receive the one or more measurements from the stationary RF tag reader, the one or more processors are configured to receive the one or more measurements from the RF tag that is integrated with the electronic shelf label.

Clause 16 The server of any one of clause 9 through clause 15, wherein the one or more processors are further configured to receive additional ranging measurements with the RF tag from the first mobile RF tag reader located at a third location and a fourth location; and determine the hybrid location information for the RF tag based on the one or more ranging measurements, the first location, the second location, the third location, and the fourth location.

Clause 17 The server of clause 16, wherein the one or more processors are further configured to receive from the first mobile RF tag reader, location information of the third location and the fourth location, wherein the location information is obtained by the first mobile RF tag reader based on one or more of global navigation satellite system (GNSS) signals, cellular signals, Wi-Fi signals, ultra-wideband (UWB) signals, Bluetooth signals, or sensor measurements.

Clause 18 An apparatus for providing location services, the apparatus comprising means for receiving, from a stationary RF tag reader, one or more measurements indicative of an RF tag; means for receiving one or more ranging measurements with the RF tag from at least a first mobile RF tag reader located at a first location; means for obtaining a second location associated with the stationary RF tag reader; and means for determining hybrid location information for the RF tag based on one or more ranging measurements, the first location, and the second location.

Clause 19 The apparatus of clause 18, wherein the means for receiving, from the stationary RF tag reader, the one or more measurements indicative of the RF tag, comprises means for receiving the one or more measurements from at least one of an electronic shelf label or a rail controller.

Clause 20 The apparatus of either clause 18 or clause 19, wherein the means for receiving the one or more ranging measurements with the RF tag from the at least the first mobile RF tag reader located at the first location comprises means for receiving the one or more ranging measurements with the RF tag from one of a mobile phone having RFID tag reading functionality or a hand-held RFID tag reader.

What is claimed is:

1. A method performed by a server for providing location services, the method comprising:
receiving, from a stationary RF tag reader, one or more measurements indicative of an RF tag;
receiving one or more ranging measurements with the RF tag from at least a first mobile RF tag reader located at a first location;
obtaining a second location associated with the stationary RF tag reader; and
determining hybrid location information for the RF tag based on the one or more ranging measurements, the first location, and the second location.

2. The method of claim 1, wherein receiving, from the stationary RF tag reader, the one or more measurements indicative of the RF tag, comprises receiving, from at least one of an electronic shelf label or a rail controller, the one or more measurements indicative of the RF tag.

3. The method of claim 2, wherein receiving the one or more ranging measurements with the RF tag from the at least the first mobile RF tag reader located at the first location comprises receiving the one or more ranging measurements with the RF tag from a mobile phone having RF tag reading functionality, the mobile phone located at the first location.

4. The method of claim 2, wherein receiving, from the stationary RF tag reader, the one or more measurements indicative of the RF tag comprises receiving, from the stationary RF tag reader, one or more measurements indicative of an RFID tag, and wherein receiving the one or more ranging measurements with the RF tag from the at least the first mobile RF tag reader located at the first location comprises receiving the one or more ranging measurements with the RF tag from one of a mobile phone having RFID tag reading functionality or a hand-held RFID tag reader.

5. The method of claim 2, wherein receiving, from the stationary RF tag reader, the one or more measurements indicative of the RF tag comprises receiving the one or more measurements with the RF tag attached to a first object placed on a storage rack, via one of the electronic shelf label or the rail controller attached to the storage rack.

6. The method of claim 1, further comprising:
providing the hybrid location information to a client entity.

7. The method of claim 1, further comprising:
receiving additional ranging measurements with the RF tag from the first mobile RF tag reader located at a third location and a fourth location; and
determining the hybrid location information for the RF tag based on the one or more ranging measurements, the first location, the second location, the third location, and the fourth location.

8. The method of claim 7, further comprising:
receiving, from the first mobile RF tag reader, location information of the third location and the fourth location, wherein the location information is obtained by the first mobile RF tag reader based on one or more of global navigation satellite system (GNSS) signals, cellular signals, Wi-Fi signals, ultra-wideband (UWB) signals, Bluetooth signals, or sensor measurements.

9. A server for providing location services, the server comprising:
at least one transceiver;
at least one memory; and
one or more processors communicatively coupled with the at least one memory and the at least one transceiver, the one or more processors configured to:
receive, via the at least one transceiver, from a stationary RF tag reader, one or more measurements indicative of an RF tag;
receive, via the at least one transceiver, one or more ranging measurements with the RF tag from at least a first mobile RF tag reader located at a first location;
obtain a second location associated with the stationary RF tag reader; and
determine hybrid location information for the RF tag based on the one or more ranging measurements, the first location, and the second location.

10. The server of claim 9, wherein, to receive the one or more measurements from the stationary RF tag reader, the one or more processors are configured to receive the one or more measurements from at least one of an electronic shelf label or a rail controller.

11. The server of claim 10, wherein to receive the one or more ranging measurements with the RF tag from the first mobile RF tag reader, the one or more processors are configured to receive the one or more ranging measurements with the RF tag from a mobile phone having RF tag reading functionality.

12. The server of claim 10, wherein, to receive the one or more measurements from the stationary RF tag reader, the one or more processors are configured to receive the one or more measurements from an RFID tag, and wherein to receive the one or more ranging measurements with the RF tag from the at least the first mobile RF tag reader, the one or more processors are configured to receive the one or more ranging measurements from one of a mobile phone having RFID tag reading functionality or a hand-held RFID tag reader.

13. The server of claim 10, wherein, to receive the one or more measurements indicative of the RF tag, the one or more processors are configured to receive the one or more measurements with the RF tag attached to a first object placed on a storage rack, via one of the electronic shelf label or the rail controller attached to the storage rack.

14. The server of claim 9, wherein the one or more processors are further configured to:
provide the hybrid location information to a client entity.

15. The server of claim 10, wherein, to receive the one or more measurements from the stationary RF tag reader, the one or more processors are configured to receive the one or more measurements from the RF tag that is integrated with the electronic shelf label.

16. The server of claim 9, wherein the one or more processors are further configured to:
receive additional ranging measurements with the RF tag from the first mobile RF tag reader located at a third location and a fourth location; and
determine the hybrid location information for the RF tag based on the one or more ranging measurements, the first location, the second location, the third location, and the fourth location.

17. The server of claim 16, wherein the one or more processors are further configured to:
receive from the first mobile RF tag reader, location information of the third location and the fourth location, wherein the location information is obtained by the first mobile RF tag reader based on one or more of global navigation satellite system (GNSS) signals, cellular signals, Wi-Fi signals, ultra-wideband (UWB) signals, Bluetooth signals, or sensor measurements.

18. An apparatus for providing location services, the apparatus comprising:
means for receiving, from a stationary RF tag reader, one or more measurements indicative of an RF tag;
means for receiving one or more ranging measurements with the RF tag from at least a first mobile RF tag reader located at a first location;
means for obtaining a second location associated with the stationary RF tag reader; and
means for determining hybrid location information for the RF tag based on one or more ranging measurements, the first location, and the second location.

19. The apparatus of claim 18, wherein the means for receiving, from the stationary RF tag reader, the one or more measurements indicative of the RF tag, comprises means for receiving the one or more measurements from at least one of an electronic shelf label or a rail controller.

20. The apparatus of claim 18, wherein the means for receiving the one or more ranging measurements with the RF tag from the at least the first mobile RF tag reader located at the first location comprises means for receiving the one or more ranging measurements with the RF tag from one of a mobile phone having RFID tag reading functionality or a hand-held RFID tag reader.
